(19) United States
(12) Patent Application Publication
(10) Pub. No.: US 2026/0245172 A1
(43) Pub. Date: Aug. 20, 2026

(54) METHOD AND DEVICE FOR ENERGY REDUCTION CONTROL OF VISUAL CONTENT

(71) Applicant: InterDigital CE Patent Holdings, SAS, Paris (FR)

(72) Inventors: Laurent BLONDE, THORIGNE-FOUILLARD (FR); Claire-Helene DEMARTY, MONTREUIL LE GAST (FR); Franck AUMONT, VERN SUR SEICHE (FR); Olivier LE MEUR, TALENSAC (FR); Erik REINHARD, HEDE-BAZOUGES (FR)

(21) Appl. No.: 19/472,447

(22) PCT Filed: Mar. 26, 2024
(86) PCT No.: PCT/EP2024/058048

§ 371 Date: Oct. 3, 2025

(30) Foreign Application Priority Data
Apr. 3, 2023 (EP) 23305480.8

(51) Int. Cl. G06T 3/4007; G06T 5/92

(52) U.S. Cl. CPC G06T 3/4007; G06T 5/92; G06T 2200/24

(57) ABSTRACT

A method and device introduce the notion of a quality/energy tradeoff control for visual contents. It provides to a user a fine and continuous control on the strength of some algorithm applied by a device to a visual content. This control enables the user to balance the quality of experience against the consumed energy for using, consuming, transmitting and/or displaying the visual content. A user may indeed find acceptable to have a lower quality of the content provided that they are rewarded by higher gain in terms of energy savings.

### CROSS-REFERENCE TO RELATED APPLICATIONS

This application claims the priority to European Application No 23305480.8 filed 3 Apr. 2023, which is incorporated herein by reference in its entirety.

### TECHNICAL FIELD

The disclosure is in the field of multimedia content distribution, and at least one embodiment relates more specifically to the control of energy consumption reduction in systems handling a visual content such as an image or video.

### BACKGROUND ART

Reducing energy consumption of electronic devices has become a requirement not only for manufacturers of electronic devices but also to limit, as much as possible, the environmental impact and to contribute to the emergence of a sustainable display industry. The increase in display resolution from SD to HD, then to 4K and soon to 8K and beyond, as well as the introduction of high dynamic range imaging, has brought about a corresponding increase in energy requirements of display devices. This is not consistent with the global need to reduce energy consumption knowing that a huge number of devices has a display (i.e., TV, Mobile phones, tablets, etc.). Indeed, displays are the most important source of energy consumption, for consumer electronic devices, either battery-powered (e.g., smartphones, tablets, head-mounted displays, car display screens) or not (e.g., television sets, advertisement display panels).

Different display technologies have been developed in the recent years. Although modern displays consume energy in a more controllable and efficient manner than older displays, they remain the most important source of energy consumption in a video chain.

As far as backlight displays are concerned, their energy consumption is largely determined by the intensity of the backlight.

Organic Light Emitting Diode (OLED) is one example of display technology that is finding increasingly widespread use because of numerous advantages compared to former technologies such as Thin-Film Transistor Liquid Crystal Displays (TFT-LCDs). Rather than using a uniform backlight, OLED displays, as well as mini LEDS, are composed of individual directly emissive image pixels. OLEDs power consumption is therefore highly correlated to the image content and the power consumption for a given input image can be estimated by considering the values of the displayed image pixels.

It is therefore interesting to elaborate energy-aware images or videos, i.e., images or videos that will need less energy when displayed, notably on consumer electronics OLED displays. Techniques have been disclosed to generate energy-aware images from original images by using a so-called dimming map that will decrease pixel values of an image to reduce the energy needed for displaying them. Such dimming map may be designed to ensure good properties such as smoothness and scalability. Another example to reduce energy consumption is to replace a pixel of an image by temporally successive pixels of alternating complementary colors or by spatially adjacent pixels of alternating complementary colors requiring less energy for display.

What is common within these techniques is that they all are based on an algorithm for reducing the energy requirements of display devices with the goal to preserve the quality of experience (QoE) based on contrast, luminance, temporal smoothness, or color levels for instance.

### SUMMARY

Image/Video Processing Algorithms dedicated to energy reduction may realize their tasks with different degrees of quality of experience: they may prevent the introduction of defects, or more precisely of visible defects; they may also create visible defects of different strength or disturbance for the end user. In case no defect or no visible defect is introduced (called flawless case in the following), there is no need to balance energy reduction with quality of experience, as the latter is not modified. This is the case in video broadcast, where there is the constraint that the image displayed on the user's screen should show as few degradations as possible for a given transmission and display environment. While an absolutely high-quality requirement is understandable for programs with a high artistic value such as feature movies, it can be evaluated that many other program types like weather forecast, talk shows, TV games, cartoons, sitcoms, advertisements, do not need an absolutely crisp quality. At least, some users may be willing to accept a reduction of the quality on selected program types in exchange of gaining some energy consumption reduction.

With another view, when defects are introduced, it is interesting as well to give access to a way to balance the energy reduction against QoE. Such defects, even if strong, are possibly acceptable to the end user and their presence can be even more accepted if the users are rewarded e.g., by energy savings.

Also, some algorithms may create some defects but might also be more efficient in energy consumption reduction than others.

In all the above cases, the balance between energy consumption gains and flawless quality needs consideration in the current energy awareness context and the fight against climate change.

Embodiments described hereafter have been designed with the foregoing in mind and introduce the notion of a quality/energy tradeoff control for visual contents. It provides to a user a fine and continuous (or nearly continuous or piece-wise continuous) control on the strength of some algorithm applied by a device to a visual content. This control enables the user to balance the quality of experience against the consumed energy for using, consuming, transmitting and/or displaying the visual content. A user may indeed find acceptable to have a lower quality of the visualization if they are rewarded by higher gain in terms of energy savings.

The purpose is to offer the users the possibility to further decrease the energy consumption by allowing a stronger content quality reduction (specifically acceptable to them), compared to an average, or compared to a value determined externally by e.g., a content creator, a content provider, a device manufacturer. Such an adjustment, specific to the users and their choices, can generate higher energy savings than typical balancing between energy reduction and QoE as today proposed by the content provider. On the other hand, in specific cases, the user may wish to increase visual quality even if it is at the cost of a supplementary energy consumption.

In both ways, giving control to the user is relevant and while presets on the implemented algorithms for energy reduction can be defined, giving control to the user on the energy reduction/quality balance for a given algorithm and in a fine and continuous manner is a true option. Indeed, presets may be conservative compared to what users are ready to accept as image modification. The presence of defects can be even more accepted if users are rewarded e.g., by energy savings.

A first aspect is directed to a method comprising obtaining a visual content, determining an algorithm strength for an algorithm that reduces the energy consumption needed for the visual content, determining a modified visual content by applying the algorithm on the visual content with the determined algorithm strength, and providing the modified visual content, wherein the modified visual content requires less energy than the visual content.

A second aspect is directed to a device comprising a processor configured to obtain a visual content, determine an algorithm strength for an algorithm that reduces the energy consumption needed for the visual content, determine a modified visual content by applying the algorithm on the visual content with the determined algorithm strength, and provide the modified visual content, wherein the modified visual content requires less energy than the visual content.

In at least one embodiment of first and second aspect, the algorithm strength is obtained through a user interface providing means for adjusting a value representative of the algorithm strength. At least one embodiment of first and second aspect further comprises obtaining an attenuation map associated with an energy reduction rate corresponding to the determined algorithm strength and wherein the algorithm comprises, for a pixel of an image of the visual content, combining the attenuation map with the visual content by adding values of attenuation map to values of the pixels or by subtracting values of attenuation map from values of the pixels or by multiplying values of attenuation map to values of the pixels.

A third aspect is directed to non-transitory computer readable medium containing comprising instructions which, when the program is executed by a computer, cause the computer to carry out the described embodiments related to the first aspect.

A fourth aspect is directed to a computer program comprising instructions which, when the program is executed by a computer, cause the computer to carry out any of the described embodiments or variants related to the first aspect.

The above presents a simplified summary of the subject matter to provide a basic understanding of some aspects of the present disclosure. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description provided below.

### BRIEF SUMMARY OF THE DRAWINGS

The present disclosure may be better understood by consideration of the detailed description below in conjunction with the accompanying figures in which:

FIG. 1 illustrates a block diagram of an example of display device in which various aspects and embodiments are implemented.

FIG. 2 illustrates an example of architecture for quality/energy tradeoff control according to an embodiment.

FIG. 3 illustrates an example process for controlling the energy consumption reduction of devices displaying a visual content according to embodiments.

FIG. 4 illustrates different examples of user interfaces for selecting an algorithm strength according to embodiments.

It should be understood that the drawings are for purposes of illustrating examples of various aspects, features and embodiments in accordance with the present disclosure and are not necessarily the only possible configurations. Throughout the various figures, like reference designators refer to the same or similar features.

### DETAILED DESCRIPTION

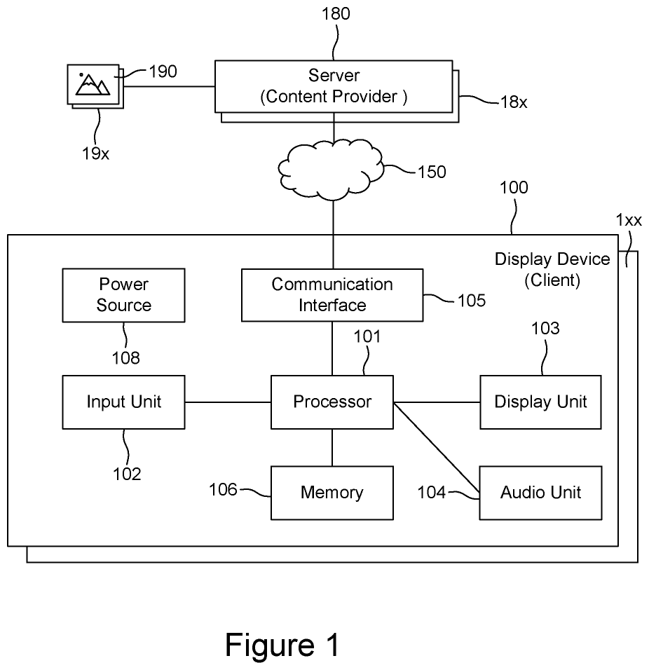

FIG. 1 illustrates a block diagram of an example of display device in which various aspects and embodiments are implemented. In the depicted environment, a user interacts with the display device 100, for example a television, that is connected to a server 180 for example operated by a content provider. The server 180 delivers multimedia content 190 such as video streams based on images. In a video distribution system, multiple devices 100, lxx are interacting with multiple content providers and corresponding servers 180, 18x delivering multiple multimedia content 190, 19x. A single content provider may use a plurality of servers. The devices exchange data through a communication network 150.

The communication network 150 preferably uses a communication standard to provide interoperability between content provider and display devices. Such communication standard may be wireless, such as cellular (e.g. LTE) communications, Wi-Fi communications, and the like, to ensure the mobility of the display device. Cable, satellite or terrestrial digital television broadcast communication may also be used for the communication network 150 as well as broadband television communications. Such digital television standards may on based on well-established standards like DVB, ATSC, or the like. General purpose network standards may also be used, for example based on Ethernet.

The display device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as the process 300 for controlling the energy consumption reduction of devices displaying a visual content of FIG. 3.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation.

The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example.

The processor 101 may be coupled to a communication interface 105 configured to exchange data with external devices. The communication preferably uses a wireless communication standard to provide mobility of the display device, such as cellular (e.g., LTE) communications, Wi-Fi communications, and the like.

The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 is configured to execute an image energy reduction algorithm that modifies an input image into an image that requires less energy when being used, for example displayed, in comparison to using the input image. Different techniques have been disclosed to provide such feature.

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the display device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the display device within its environment. The localization unit may integrate a GPS chipset providing longitude and latitude position regarding the current location of the display device but also other motion sensors such as an accelerometer and/or an e-compass that provide localization services.

In at least one embodiment, the processor 101 of the display device 100 is configured to display on the display unit 103 an image according to embodiments described further below. In a first variant embodiment, the image 190 is obtained from the content provider server 180 through the communication network 150. In a second variant embodiment, the image is obtained from the memory 106, stored for example after being captured by the input unit 102 or being transferred from a server.

Typical examples of device 100 are smartphones, tablets, laptops, monitors, head-mounted displays, television sets, video projectors, computer screens, vehicles (e.g., control and/or entertainment systems for cars, planes, boats, etc.), advertisement display panels, medical monitors, etc. However, any device or composition of devices that provides similar functionalities can be used as display device 100 while still conforming with the principles of the disclosure.

In at least one embodiment, the device does not include a display unit but prepares data representative of an energy-reduced visual content so that another device can utilize the energy-reduced visual content for further processing. In at least one embodiment, such device prepares data to be displayed by another device such as a screen. Example of such devices are set top boxes, media players, desktop computers, encoders, decoders, servers, computing grids, cloud computers, etc.

At least one example of an embodiment can involve a device including an apparatus as described herein and at least one of (i) an antenna configured to receive a signal, the signal including data representative of the image information, (ii) a band limiter configured to limit the received signal to a band of frequencies that includes the data representative of the image information, and (iii) a display configured to display an image from the image information.

At least one example of an embodiment can involve a device as described herein, wherein the device comprises one of a television, a television signal receiver, a set-top box, a gateway device, a mobile device, a cell phone, a tablet, a computer, a laptop, or other electronic device.

In general, the objective of the different energy-reduction systems for visual content is primarily to minimize the energy consumption of visual media presentation or display, on TV sets or on mobile displays. The consumption reduction is generally performed while maintaining/mastering the QoE (Quality of Experience) of the visual media presentation.

For many algorithms, a parameter, for example named Algorithm Strength, which acts on the level of energy reduction in link with the quality level can be defined. For a given energy reduction corresponding to a given quality level, Algorithm Strength may be determined analytically or with user tests. What we define here as ‘Algorithm Strength’ is, in practice, a parameter in the algorithm acting on the video images modification, such that, depending on this Algorithm Strength, different and continuous energy reduction levels are reached and a corresponding QoE is obtained. In other words, increasing the Algorithm Strength will result in increasing the energy reduction while decreasing the Algorithm Strength will result in decreasing the energy reduction.

Limiting the Algorithm Strength to the flawless case (i.e., when no visual degradation is perceived by the viewer) is the common practice when the reference is the content creators' intent or the broadcasters' choice of highest visual quality. The strength is then often adjusted to satisfy a non-visible degradation objective. In this case, during user tests, a difference of 1 JND (Just Noticeable Difference) maximum is sought, where 1 JND is defined as the amount of change in a value of something for a difference to be noticeable, or detectable at least half of the time.

Starting from a conservative strength state with no visible default in average, algorithms may evolve in the direction of stronger energy reduction while producing acceptable flaws. In this case the algorithm Strength is increased. The Algorithm Strength can go up to a level where some defects become slightly visible, or more and more visible when the Algorithm Strength increases. However, some defects, even if strong, are possibly acceptable to the end user and their presence can be even more accepted if the users are rewarded e.g., by energy savings.

On this basis, at least one embodiment proposes to adjust the quality/energy tradeoff by adjusting the level of the Algorithm strength. With such a system, the users may choose to sacrifice a part of their visual satisfaction with the benefit to consume less energy.

In embodiments, the quality of experience is not measured but appreciated by the user according to a visual feedback that possibly shows artefacts that may be considered as acceptable or not by the user. In other embodiments, the quality of experience is measured using conventional image quality metrics (i.e., PSNR, SSIM, VMAF).

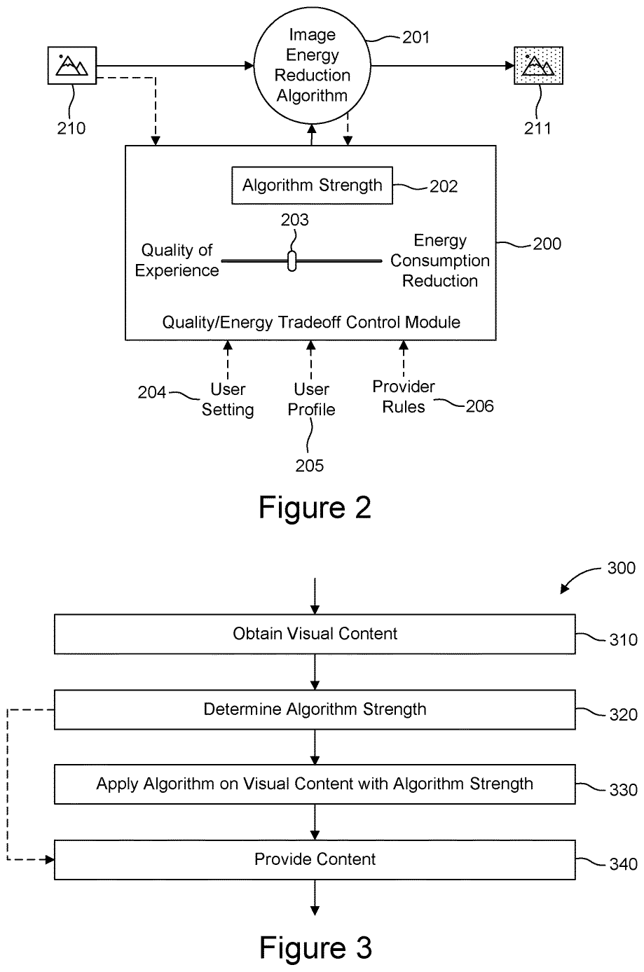

FIG. 2 illustrates an example of architecture for quality/energy tradeoff control according to an embodiment. This architecture is for example implemented by a device such as the device 100 of FIG. 1. The device comprises an image energy reduction algorithm 201 that transforms an input image 210 into a modified image 211 that requires less energy when being used. This algorithm is for example based on the principles of applying a dimming map (a.k.a attenuation map) as described in PCT/EP2023/082360, or using temporally alternating complementary colors as described in PCT/EP2023/085301 or using spatially alternating complementary colors described in PCT/EP2023/085303.

The device comprises a quality/energy tradeoff control module 200 that handles the tradeoff 203 between the quality of experience and the energy consumption reduction when using a visual content. This control is done by setting the appropriate value for the Algorithm Strength 202 that impacts the image energy reduction algorithm. The tradeoff is driven by several inputs comprising for example a user setting 204, a user profile 205, or content provider rules 206. Information from the algorithm 201 or from the images 210, 211 may also be considered. In at least one embodiment, the algorithm strength value is one minus the energy reduction rate value.

This approach could be used for less critical viewing applications, or in cases where a viewer wishes to reduce the energy consumption of the device and would be willing to accept a certain degradation of visual quality for the type of content he is watching. Such a user-adjustable method could be considered for example in a streaming scenario where the user's choice could determine which content should be sent to him.

As some defects may be more or less visible, the quality/energy tradeoff control module provides to the user some control of the defects' amplitude via the Algorithm Strength, to favor either visual comfort or consumption reduction.

In a first embodiment, the control is directly done by the user, in other words, directly controlled by a user setting 204 such as an action on a user interface element while displaying the visual content. Direct control may be provided by user input for example through a slider, a checkbox, a button, or any other user interface element that will allow the user to increase or decrease, directly or indirectly, the algorithm strength value. Such action impacts the amount of energy savings in correlation with the level of quality of experience.

In a second embodiment, the control is done indirectly by the user, for example through some settings or parameters in a user profile 205. These settings may use the same user interface elements than the first embodiment to input the user choice with the difference that these settings would apply to all visual contents. In at least one embodiment, the user profile 205 can also be replaced by a device configuration. Indeed, a user profile is dependent on the user (or group of users) utilizing the device, so it requires an identification of a user to benefit from a user profile. A device configuration applies to all users of the device and thus, does not need such identification. Both offer the same feature: allowing to setup some parameters in a configuration phase and apply these parameters during the normal use of the device to adapt the behavior to user or device preferences.

In a third embodiment, the control is done according to provider rules 206, in other words the quality/energy tradeoff is decided by the provider of the content and enforced by the device. For example, the provider of a blockbuster movie wants the audience to enjoy the pristine images and this prevents any unintended processing of the images to ensure that the artistic intent of the producer is perceived. At the opposite, a producer of a talk show on the topic of environmental issues may want to enforce a maximal energy reduction to be consistent with the topic of the show.

In a fourth embodiment, all the above settings are combined together. A priority mechanism is defined to prevent any conflicting settings, for example giving higher priority to the user settings over the other settings. Another option is to assign weights to each type of settings, and to realize a weighted sum.

In a variant embodiment applicable to all the embodiments described herein, the choice of the user is further displayed through either the new amount of energy needed to display the content or the new quality level corresponding to the user choice or both the energy amount and the quality level, as an informative and optional feedback to the user. This amount of energy and/or quality can be displayed through numbers, colors, histogram bars or any other user interface widget that displays an amount of a characteristic. As far as the energy is concerned, the amount of energy consumed, or the amount of saved energy can be displayed. In the latter case, the feedback to the user can be transformed into the amount of carbon emission and/or a more illustrative and figurative representation such as icons illustrating the “wellness of the planet” for example.

FIG. 3 illustrates an example process for controlling the energy consumption reduction of devices displaying a visual content according to embodiments. This process 300 is for example implemented by a processor 101 of a device 100 of FIG. 1. In step 310, the processor obtains the visual content, or a part of the visual content, for example an image of a sequence of images. In step 320, the processor determines the algorithm strength. As described above this may be based on multiple inputs such as user setting, a user profile, a system status or rules from the content provider. In step 330, the energy reduction algorithm is applied to the visual content with the determined algorithm strength. A low value of the strength will only slightly impact the outcome. In at least one embodiment, when the value of the algorithm strength is null or lower than a threshold value, the algorithm is not applied (dotted line in the figure). Indeed, if the energy reduction is not significative enough, the energy needed for computing a modified content may be higher than the energy savings that would be provided by the modified content. Example values of such threshold are 0.1 or 0.05.

The application of the energy reduction algorithm can be done using an attenuation (or dimming) map. In this case, pixels of an image of the visual content are combined with an attenuation that, for example, reduces the level of the pixels while ensuring a satisfying quality of experience. In at least one embodiment, the combination is done through a scaling operation, in other words, by multiplying the values of the pixels of the image by values of corresponding pixels (i.e., at the same location in the image) of the attenuation map. In this case, the pixels of the attenuation map are floating values selected in a range between 0.0 and 1.0. In at least one embodiment, the combination is done through a subtraction, by subtracting the values of the pixels of the attenuation map from the values of the pixels of the image. In this case, the pixels of the attenuation are positive values selected in a range between 0 and the maximal pixel range value (e.g. 255 if expressed on 8 bits). In at least one embodiment, the combination is done through an addition, by adding the values of the pixels of the attenuation map from the values of the pixels of the image. In this case, the pixels of the attenuation are negative values selected in a range between “minus the maximal pixel range value minus one” (e.g. −254 if expressed on 8 bits).

In step 340, the processor provides the modified (or unmodified) content. In an embodiment, the content is then directly displayed on the screen. In other embodiments, the content is provided to another device for further use, such as processing or display on another device.

The computation of the algorithm strength in step 320 is indeed dependent on the algorithm itself. In the example of PCT/EP2023/082360, an attenuation map corresponding to a given energy reduction rate is determined for an input image. This attenuation map also corresponds to a given level of quality of experience. The proposed technique allows to infer another attenuation map from a first attenuation map by linearly scaling the original attenuation map to obtain a smaller energy reduction rate.

Such a linear scaling could be applied to obtain an attenuation map with a lower energy reduction rate \hat{R}, such that R>\hat{R}. In this case, it is expected that the quality of experience will also increase. Noting I an original image and I_{R}, its energy-aware version by reducing the energy consumption by R, the equation below gives an example of how to modify the corresponding attenuation map DM(I_{R}) by linear scaling, in case R>\hat{R} using a ratio as follows:

$$DM ( {I}_{\hat{R}} ) = DM ( {I}_{R} ) \times \frac{\hat{R}}{R}$$

In at least one embodiment, the energy aware image corresponding to the attenuation map DM(i|R) is constructed by subtracting the attenuation map to the original image:

$${I}_{\hat{R}} = I + DM ( {I}_{\hat{R}} )$$

In another embodiment, the user requests to achieve a reduction greater than the reduction provided by the attenuation map: \hat{R}>R. In this case, it is necessary to additionally clamp the resulting energy-aware image to positive values, or to clamp the resulting attenuation map to values in the range [0, max(I)].

In any case, (1−\hat{R}) can be used as the Algorithm Strength defined in the previous section.

In at least one embodiment, the energy aware image corresponding to the attenuation map DM(I_{R}) is constructed by multiplying the original image with the attenuation map:

$${I}_{R} = I + DM ( {I}_{R} )$$

In this case, values in the attenuation map should be in the range [0,1]. Starting from one single attenuation map corresponding to an energy reduction rate R, other attenuation maps corresponding to other energy reduction rates are determined by scaling the attenuation map according to a ratio based on an energy reduction rate R and a target energy reduction rate \hat{R}. This is done, in both cases introduced above, by applying the following equations:

$$If R > \hat{R} : DM ( {I}_{\hat{R}} ) = DM ( {I}_{R} ) + ( 1 - DM ( {I}_{R} ) ) \times \frac{\hat{R}}{R}$$

$$If \hat{R} > R : DM ( {I}_{\hat{R}} ) = DM ( {I}_{R} ) \times \frac{R}{\hat{R}}$$

In this case again, (1−\hat{R}) will also correspond to the Algorithm Strength.

PCT/EP2023/083362 proposes the transmission of multiple attenuation maps corresponding to one of several energy reduction rates and associated quality of experiences for a given input image, thus allowing to interpolate a couple of attenuation maps to infer another attenuation map from a couple of attenuation maps through a bilinear interpolation of the couple of attenuation maps, in addition to the previous technique.

In this case again, (1−\hat{R}) will also correspond to the Algorithm Strength.

In a global system where the user impacts the construction of the attenuation map (in opposition to only receiving a content and at least one associated attenuation map) the construction of the attenuation map may be driven by some interaction with the end user, who would choose the Algorithm Strength (1−R). This strength directly determines the target energy reduction rate R, the expected quality of the resulting energy aware image, and thus the construction of the attenuation map. In addition, the construction of the first attenuation map could be dependent on some end user or end-device target energy profile. The choice of the Algorithm Strength may also be guided by the end device itself based on other parameters such as the battery status or the expected video duration.

In a global system where the user impacts the distribution of the attenuation map (for example in a DASH based streaming environment), the user would be able to choose one or another attenuation map depending on their associated energy reduction rates and expected quality of experience levels, provided that they are classified by ordered Algorithm Strengths.

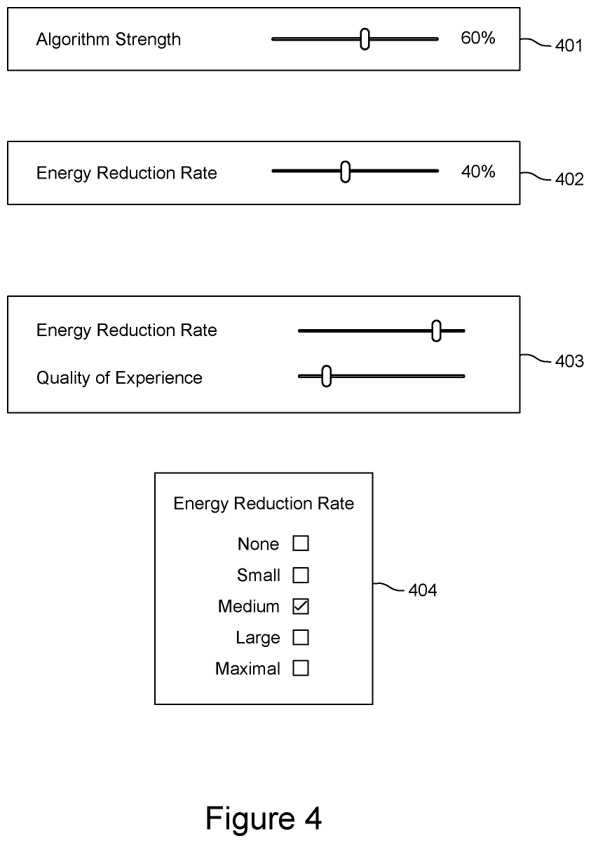

FIG. 4 illustrates different examples of user interfaces for selecting an algorithm strength according to embodiments. These examples illustrate only the graphical element of a user interface that allows to control the strength. They do not include a complete user interface.

A first example of graphical element for controlling the algorithm strength 401 is based on a slider that directly drives the Algorithm Strength, for example expressed in percentage of the maximal strength. Moving the cursor towards the right side increases the algorithm strength. Moving the cursor towards the left side decreases the algorithm strength. The cursor may be moved using conventional techniques such as using left and right arrows or by direct control through a touch screen. A value equal to zero (i.e., cursor at the far-left side) disables the energy reduction and bypasses the image modification. Optionally the user may also directly enter a numeric value, for example using digit keys or voice input. Optionally, a color range could be associated to the slider, varying between green on the right side and red on the left side, the more on the green side the more energy reduction.

A second example of graphical element for controlling the algorithm strength 402 is based on a slider that drives the energy reduction rate provided by the algorithm, for example expressed in percentage of reduction. Optionally the user may also directly enter a numeric value or use a color range.

A third example of graphical element for controlling the algorithm strength 403 is based on a couple of interconnected sliders showing the relationship between energy reduction and quality of experience. Indeed, when the user increases the energy reduction rate using the slider on the top, the value of the second slider decreases simultaneously and vice versa. Optionally the user may also directly enter a numeric value or use a color range.

A fourth example of graphical element for controlling the algorithm strength 404 is based on a user interface panel where the user may select the algorithm strength amongst checkboxes labelled as “no energy reduction”, “small reduction”, “medium reduction”, “large reduction”, “maximal reduction”.

In addition, the user interface may also display in indication of a measure of the quality of experience, for example in the form of a numerical value (i.e., percentage of similarity).

The person skilled in the art would think of many other conventional techniques (voice controlled, gestures, etc.) for entering the algorithm strength.

Although some parts of the description refer to images, the embodiments are not restricted to images and apply to any type of visual media content such as conventional (2D) videos, stereoscopic (3D) images or videos, 360° immersive images or video, based on the same principles as described above but iterated temporally and/or spatially.

In general, one or more other examples of embodiments can also provide a computer readable storage medium, e.g., a non-volatile computer readable storage medium, having stored thereon instructions for encoding or decoding picture information such as video data according to the methods or the apparatus described herein. One or more embodiments can also provide a computer readable storage medium having stored thereon a bitstream generated according to methods or apparatus described herein. One or more embodiments can also provide methods and apparatus for transmitting or receiving a bitstream or signal generated according to methods or apparatus described herein.

Many of the examples of embodiments described herein are described with specificity and, at least to show the individual characteristics, are often described in a manner that may sound limiting. However, this is for purposes of clarity in description, and does not limit the application or scope of those aspects. Indeed, all the different aspects can be combined and interchanged to provide further aspects. Moreover, the embodiments, features, etc. can be combined and interchanged with others described in earlier filings as well.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

When a figure is presented as a flow diagram, it also provides a block diagram of a corresponding apparatus. Similarly, when a figure is presented as a block diagram, it also provides a flow diagram of a corresponding method/process.

In general, the examples of embodiments, implementations, features, etc., described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. One or more examples of methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users. Also, use of the term “processor” herein is intended to broadly encompass various configurations of one processor or more than one processor.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Various embodiments are described herein. Features of these embodiments can be provided alone or in any combination, across various claim categories and types.

1. A method comprising:
obtaining a visual content;
determining an algorithm strength for an algorithm that reduces an energy consumption needed for the visual content, wherein the algorithm strength is based on a user setting, or a user profile, or a system status or rules from a content provider and is a numerical parameter controlling a trade-off between energy consumption reduction and a quality of experience;
determining a modified visual content by applying a pixel-based attenuation map on the visual content, wherein the modified visual content consumes less energy than the visual content when being displayed, wherein the attenuation map is selected based on the determined algorithm strength, wherein increasing the algorithm strength increases the reduction of the energy consumption and decreasing the algorithm strength decreases the reduction of the energy consumption; and
providing the modified visual content.

2. The method of claim 1, wherein the algorithm strength is a user setting obtained through a user interface providing means for adjusting a value representative of the algorithm strength.

3. The method of claim 1, wherein the algorithm strength is a configuration setting based on a user profile, or a system status or rules from a content provider and obtained from a memory of the apparatus implementing the method.

4. The method of claim 3, wherein the memory comprises a list of algorithm strengths associated to a classification-based category for visual contents and further comprising selecting the algorithm strength associated with the category of the obtained visual content.

5. The method of claim 1, further comprising obtaining an attenuation map associated with an energy reduction rate corresponding to the determined algorithm strength and wherein the algorithm comprises, for a pixel of an image of the visual content, combining the attenuation map with the visual content by adding values of the attenuation map to values of the pixels or by subtracting values of the attenuation map from values of the pixels or by multiplying values of the attenuation map by values of the pixels.

6-7. (canceled)

8. The method of claim 1 wherein, when none of the energy reduction rates associated with a plurality of attenuation maps is equal to the energy reduction rate corresponding to the determined algorithm strength, further comprising:
obtaining a first attenuation map whose associated energy reduction rate is different from the energy reduction rate corresponding to the determined algorithm strength;
generating a second attenuation map by scaling the first attenuation map according to a ratio determined based on the energy reduction rate associated to the first attenuation map and the energy reduction rate corresponding to the determined algorithm strength; and
for a pixel of an image of the visual content, combining the second attenuation map with the visual content by adding, subtracting or multiplying values of the second attenuation map by values of the pixels of the image of the visual content.

9. The method of claim 1 wherein, when none of the energy reduction rates associated with a plurality of attenuation maps is equal to the energy reduction rate corresponding to the determined algorithm strength, further comprising:
obtaining a first attenuation map whose associated energy reduction rate is greater than the energy reduction rate corresponding to the determined algorithm strength;
obtaining a second attenuation map whose associated energy reduction rate is smaller than the energy reduction rate corresponding to the determined algorithm strength;
generating a third attenuation map by performing a bilinear interpolation between the first and the second attenuation map based on the energy reduction rates associated to the first and second attenuation maps and the energy reduction rate corresponding to the determined algorithm strength; and
for a pixel of an image of the visual content, combining the third attenuation map with the visual content by adding, subtracting or multiplying values of the third attenuation map by values of the pixels of the image of the visual content.

10. An apparatus comprising a processor configured to:
obtain a visual content;
determine an algorithm strength for an algorithm that reduces the energy consumption needed for the visual content, wherein the algorithm strength is based on a user setting, or a user profile, or a system status or rules from a content provider and is a numerical parameter controlling a trade-off between energy consumption reduction and a quality of experience;
determine a modified visual content by applying a pixel-based attenuation map on the visual content, wherein the modified visual content consumes less energy than the visual content when being displayed, wherein the attenuation map is selected based on the determined algorithm strength, wherein increasing the algorithm strength increases the reduction of the energy consumption and decreasing the algorithm strength decreases the reduction of the energy consumption; and
provide the modified visual content.

11. The apparatus of claim 10, wherein the algorithm strength is a user setting obtained through a user interface providing means for adjusting a value representative of the algorithm strength.

12. The apparatus of claim 10, wherein the algorithm strength is a configuration setting based on a user profile, or a system status or rules from a content provider and obtained from a memory of the device implementing the method.

13. The apparatus of claim 12, wherein the memory comprises a list of algorithm strengths associated with a classification-based category for visual contents and further comprising selecting the algorithm strength associated to the category of the obtained visual content.

14. The apparatus of claim 10, further comprising obtaining an attenuation map associated with an energy reduction rate corresponding to the determined algorithm strength and wherein the algorithm comprises, for a pixel of an image of the visual content, combining the attenuation map with the visual content by adding values of attenuation map to values of the pixels or by subtracting values of attenuation map from values of the pixels or by multiplying values of attenuation map by values of the pixels.

15-16. (canceled)

17. The apparatus of claim 10, wherein, when none of the energy reduction rates associated with a plurality of attenuation maps is equal to the energy reduction rate corresponding to the determined algorithm strength, further comprising:
obtaining a first attenuation map whose associated energy reduction rate is different from than the energy reduction rate corresponding to the determined algorithm strength;
generating a second attenuation map by scaling the first attenuation map according to a ratio determined based on the energy reduction rate associated to the first attenuation map and the energy reduction rate corresponding to the determined algorithm strength; and
for a pixel of an image of the visual content, combining the second attenuation map with the visual content by adding, subtracting, or multiplying values of the second attenuation map by values of the pixels of the image of the visual content.

18. The apparatus of claim 10 wherein, when none of the energy reduction rates associated with a plurality of attenuation maps is equal to the energy reduction rate corresponding to the determined algorithm strength, further comprising:
obtaining a first attenuation map whose associated energy reduction rate is greater than the energy reduction rate corresponding to the determined algorithm strength;
obtaining a second attenuation map whose associated energy reduction rate is smaller than the energy reduction rate corresponding to the determined algorithm strength;
generating a third attenuation map by performing a bilinear interpolation between the first and the second attenuation map based on the energy reduction rates associated to the first and second attenuation maps and the energy reduction rate corresponding to the determined algorithm strength; and
for a pixel of an image of the visual content, combining the third attenuation map with the visual content by adding, subtracting or multiplying values of the third attenuation map by values of the pixels of the image of the visual content.

19. The apparatus of claim 10 selected in a set comprising smartphones, tablets, laptops, monitors, head-mounted displays, television sets, video projectors, computer screens, control and/or entertainment systems for vehicles, advertisement display panels, and medical monitors.

20. (canceled)

21. A non-transitory computer readable medium storing instructions that, when executed by a processor, cause the processor to:
obtain a visual content;
determine an algorithm strength for an algorithm that reduces the energy consumption needed for the visual content, wherein the algorithm strength is based on a user setting, or a user profile, or a system status or rules from a content provider and is a numerical parameter controlling a trade-off between energy consumption reduction and a quality of experience;
determine a modified visual content by applying a pixel-based attenuation map on the visual content, wherein the modified visual content consumes less energy than the visual content when being displayed, wherein the attenuation map is selected based on the determined algorithm strength, wherein increasing the algorithm strength increases the reduction of the energy consumption and decreasing the algorithm strength decreases the reduction of the energy consumption; and
provide the modified visual content.
